(19) United States
(12) Patent Application Publication
(10) Pub. No.: US 2020/0025703 A1
(43) Pub. Date: Jan. 23, 2020

(54) HUMIDITY SENSOR ARRANGEMENT

(71) Applicant: E+E Elektronik Ges.m.b.H., Engerwitzdorf (AT)

(72) Inventor: Albin Haider, Alberndorf (AT)

(21) Appl. No.: 16/484,832

(22) PCT Filed: Dec. 20, 2017
(86) PCT No.: PCT/EP2017/083713

§ 371 Date: Aug. 9, 2019

(30) Foreign Application Priority Data
Feb. 21, 2017 (EP) 17157078.1

(51) Int. Cl. G01N 27/22

(52) U.S. Cl. CPC G01N 27/223; G01N 27/226

(57) ABSTRACT

A humidity sensor assembly includes an integrated signal-processing component. A capacitive humidity sensor is disposed on the signal-processing component. An encapsulation partially surrounds the signal-processing component and has an opening in a region of the humidity sensor. A low-resistance, electrically conductive dissipation element is disposed in a region of the opening such that, in an event of an electrostatic discharge, a resulting discharge current is dischargeable through the at least one dissipation element at least to an extent that sensitive portions of the signal-processing component remain safe.

### CROSS-REFERENCE TO PRIOR APPLICATIONS

This application is a U.S. National Stage Application under 35 U.S.C. § 371 of International Application No. PCT/EP2017/083713 filed on Dec. 20, 2017, and claims benefit to European Patent Application No. EP 17157078.1 filed on Feb. 21, 2017. The International Application was published in German on Aug. 30, 2018, as WO 2018/153532 A1 under PCT Article 21(2).

### FIELD

The present invention relates to a humidity sensor assembly.

### BACKGROUND

EP 2 755 023 A1 describes a humidity sensor assembly including an integrated signal-processing component on which is disposed a capacitive humidity sensor. The capacitive humidity sensor is configured as a parallel-plate capacitor having a planar bottom electrode and a moisture-permeable, planar top electrode, between which is disposed a dielectric measuring layer having a moisture-dependent capacitance. Furthermore, an encapsulation or potting compound is disposed around the capacitive humidity sensor to protect the assembly from mechanical damage and the signal-processing component from humidity. In the region of the top electrode, the encapsulation has an opening through which the surrounding medium can come into contact with the porous top electrode. The generated measurement signals are further processed in the signal-processing component and may thereby also be suitably conditioned for transmission to subsequent electronics.

If such a humidity sensor assembly is disposed, for example, on a circuit board, then uncontrolled electrostatic discharges (ESD) may occur during further processing of the circuit board. Such discharges can destroy the components on the circuit board. For example, the humidity sensor assembly, and in particular the signal-processing component, can be damaged when a discharge occurs in the region of the opening of the encapsulation. The publication mentioned does not describe any measures capable of reliably preventing such damage to the humidity sensor assembly.

### SUMMARY

In an embodiment, the present invention provides a humidity sensor assembly including an integrated signal-processing component. At least one capacitive humidity sensor is disposed on the signal-processing component. An encapsulation partially surrounds the signal-processing component and has an opening in a region of the at least one humidity sensor. At least one low-resistance, electrically conductive dissipation element is disposed in a region of the opening such that, in an event of an electrostatic discharge, a resulting discharge current is dischargeable through the at least one dissipation element at least to an extent that sensitive portions of the signal-processing component remain safe.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a perspective view of a first exemplary embodiment of the humidity sensor assembly according to the present invention;

FIG. 2 is a partial exploded view of the first exemplary embodiment of the inventive humidity sensor assembly shown in FIG. 1;

FIG. 3 is a plan view of a portion of the inventive humidity sensor assembly of FIG. 1;

FIGS. 4a-4c are different cross-sectional views of the inventive humidity sensor assembly of FIG. 1;

FIG. 5 is a perspective cross-sectional view of a portion of the first exemplary embodiment of the inventive humidity sensor assembly shown in the preceding figures;

FIG. 6 is a plan view of a portion of a second exemplary embodiment of the humidity sensor assembly according to the present invention;

FIG. 7 is a cross-sectional view of the humidity signal sensor assembly of FIG. 6;

FIG. 8 is a perspective cross-sectional view of a portion of the second exemplary embodiment of the humidity sensor assembly according to the present invention.

### DETAILED DESCRIPTION

In an embodiment, the present invention provides a humidity sensor assembly that is prevented, to the extent possible, from being damaged and thereby becoming inoperable even in the case of uncontrolled electrostatic discharges.

The humidity sensor assembly according to an embodiment of the present invention includes an integrated signal-processing component, at least one capacitive humidity sensor disposed on the signal-processing component, and an encapsulation that partially surrounds the signal-processing component and has an opening in the region of the humidity sensor. At least one low-resistance, electrically conductive dissipation element is disposed in the region of the opening. In the event of an electrostatic discharge, the resulting discharge current can be discharged through the dissipation element at least to the extent that sensitive portions of the signal-processing component remain safe.

In a possible embodiment, the capacitive humidity sensor is composed of

at least one planar bottom electrode disposed on the signal-processing component,

a measuring layer which is disposed above the bottom electrode and whose capacitance varies as a function of humidity, as well as

at least one moisture-permeable, planar top electrode disposed above the measuring layer.

In the case of a parallel-plate capacitor design, the surfaces of the bottom electrode and/or of the top electrode may each cover only a portion of the projection of the opening into the bottom electrode plane and/or the top electrode plane.

In this case, one or more dissipation elements may be disposed at least in the non-covered portion of the projection of the opening in the bottom electrode plane.

Furthermore, the opening may be circular in cross section, and the bottom electrode and/or the top electrode may each be circular segment-shaped in the region of the projection of the opening into the bottom electrode plane and/or the top electrode plane.

The bottom electrode and/or the top electrode may include two circular segments arranged in mirror symmetry to each other, and two circular segment-shaped dissipation elements may be disposed at least in the regions outside the circular segments, which dissipation elements are also arranged in mirror symmetry to each other.

In an embodiment, the at least one dissipation element may extend over further surface areas above the signal-processing component outside the projection of the opening.

It is also possible for the at least one dissipation element to extend over the entire surface area of the signal-processing component outside the projection of the opening.

A preferred embodiment provides that

the signal-processing component have an uppermost metal wiring plane toward the humidity sensor, and

a passivation layer be disposed over the metal wiring plane, and

the at least one bottom electrode and the at least one dissipation element be disposed in a bottom electrode plane located above the passivation layer, and

the measuring layer, which at least includes cutouts in the region of the at least one dissipation element, be disposed in a measuring layer plane located above the bottom electrode plane, and

the at least one top electrode be disposed above the at least one bottom electrode in a top electrode plane located above the measuring layer plane.

Preferably, the at least one dissipation element is composed of a metal layer.

In this connection, it is advantageous if the metal layer has a lower electrical resistance than the other metallic components of the capacitive humidity sensor.

Advantageously, the at least one dissipation element dissipates the discharge current to ground or to the supply voltage of the signal-processing component.

Furthermore, it may be provided to dissipate the discharge current using a separate bond wire that is not used for connection to ground or for supplying power to the signal-processing component.

Furthermore the at least one dissipation element may cover only a portion of the projection of the opening and taper to a point toward the center of the projection of the opening.

In an advantageous embodiment, a moisture-permeable protective layer is disposed in the opening above the capacitive humidity sensor, the at least one dissipation element being located in a region of the opening where the protective layer has its minimum thickness.

The measures according to embodiments of the present invention now make it possible to reliably prevent damage to and failure of the signal-processing component even in the case of uncontrolled electrostatic discharges in the vicinity of the humidity sensor assembly. A potential electrostatic discharge to the high-resistance humidity sensor or the signal-processing component is avoided and the resulting discharge current is otherwise dissipated in a defined manner. Thus, in particular, the discharge current is not conducted within the signal-processing component, but in preferably at least one dissipation element formed as a metallization layer above a passivation layer. In this way, rapid voltage drops and their capacitive couplings caused by the discharge current will not have any effect within the signal-processing component, and a robust design is obtained for the signal-processing component.

Further details and advantages of the present invention will be apparent from the following description of exemplary embodiments of the humidity sensor assembly according to the present invention when considered in conjunction with the figures.

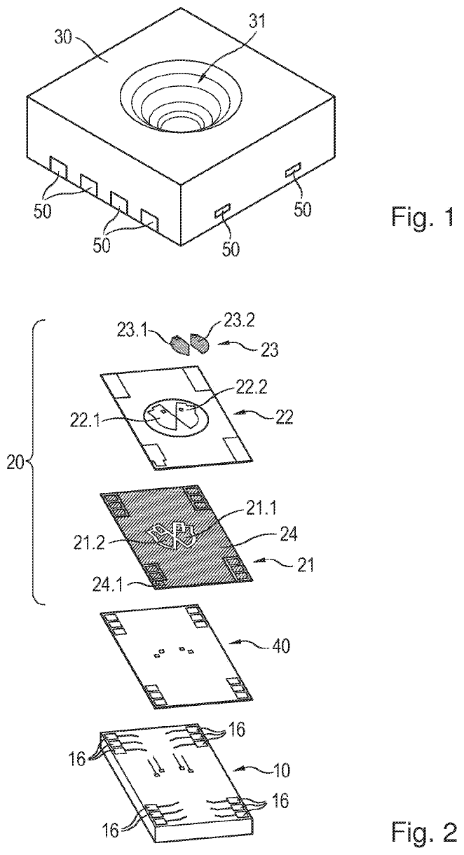

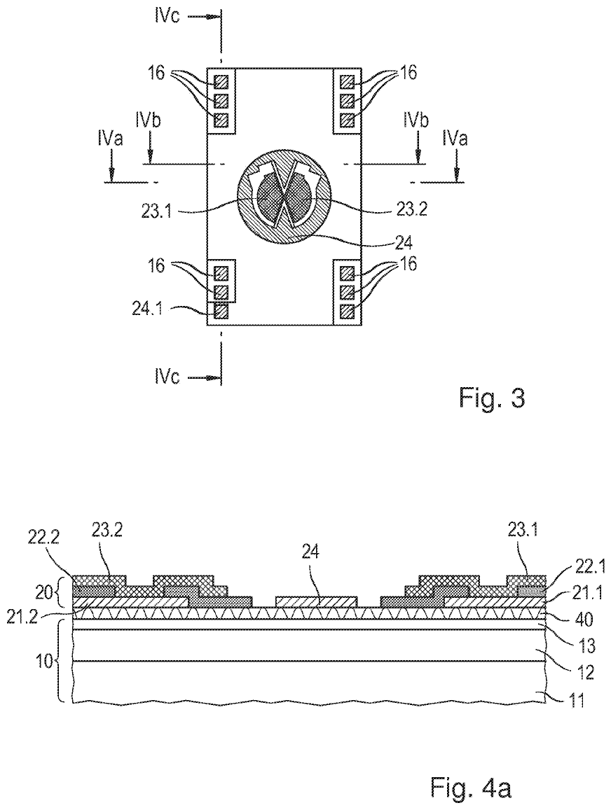

A first exemplary embodiment of the humidity sensor assembly according to the present invention will now be described with reference to FIGS. 1-5.

The following description of exemplary embodiments, which makes reference to aforementioned figures, uses directional terminology, such as “top side,” “bottom side,” etc., to refer to the relative spatial orientation of the individual components of the inventive sensor assembly 10. However, it is within the scope of the present invention that these components could, in principle, be positioned differently relative to one another and, therefore, the directional terminology used hereinafter should not be construed to be limiting in any way.

FIG. 1 shows, in perspective view, a first exemplary embodiment of the sensor assembly according to the present invention. Further details of this exemplary embodiment will be apparent from the views shown in FIGS. 2, 3, 4a-4c and 5, which are exploded, plan and cross-sectional views showing portions of the sensor assembly with and without encapsulation, as well as a perspective, partial cross-sectional view thereof.

The inventive sensor assembly includes an integrated signal-processing component 10 or ASIC, on which at least one capacitive humidity sensor 20 is disposed. Humidity sensor 20 is composed of a single-piece or multi-piece, planar bottom electrode 21.1, 21.2, a measuring layer 22 disposed above bottom electrode 21.1, 21.2 and having a moisture-dependent capacitance, and a moisture-permeable, single-piece or multi-piece planar top electrode 23.1, 23.2 disposed above measuring layer 22. For details of the construction of the humidity sensor, reference is made to the following description. Humidity sensor 20 is used to generate humidity-dependent signals which characterize the gas surrounding the sensor assembly and which are converted by signal-processing component 10 into humidity measurement values that can be further processed. The humidity measurement values may then be further processed by subsequent electronics in many different ways.

As shown in FIG. 1, an encapsulation 30 surrounds signal-processing component 10 at least partially. Encapsulation 30 protects signal-processing component 10 both from mechanical influences and from moisture. In the region of top electrode 23.1, 23.2 of humidity sensor 20, encapsulation 30 has an opening 31 allowing the surrounding gas to access humidity sensor 20 therethrough. In the exemplary embodiment shown, the opening is circular in cross section and narrows in a funnel-like or crater-like manner from the top side of encapsulation 30 toward humidity sensor 20 or toward top electrode 23.1, 23.2 of humidity sensor 20. Encapsulation 30 is formed during a transfer molding process in such a way that a cuboid shape is obtained for the sensor assembly. The material used for encapsulation 30 may be, for example, epoxy resin.

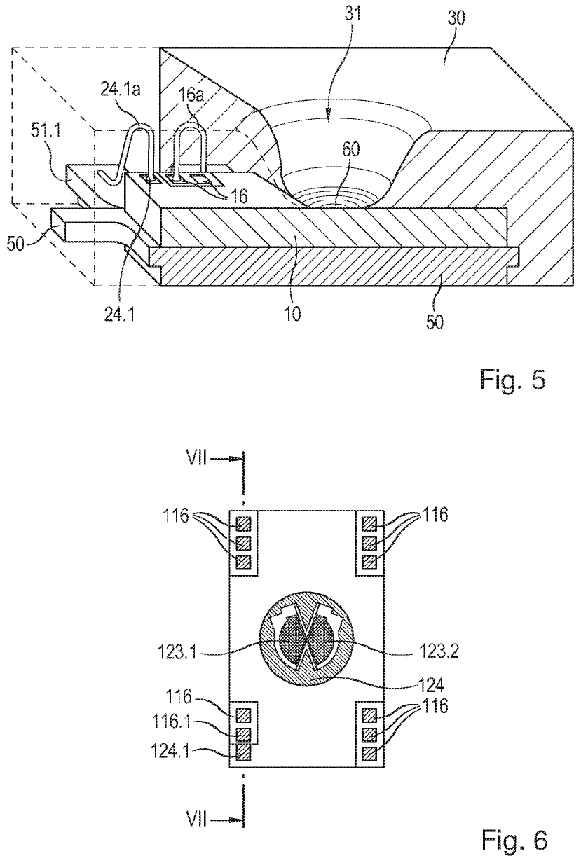

Signal-processing component 10 is disposed within encapsulation 30 on an electrically conductive carrier element 50 in the form of what is known as a lead frame, some parts of which are visible in FIGS. 1 and 5 only. As illustrated in FIG. 5, signal-processing component 10 is electrically contacted via bond wires 16a disposed between carrier element 50 and contact regions 16 or bond pads on the top side of signal-processing component 10. Carrier element 50 is then electrically connected to subsequent electronics.

Furthermore, a moisture- and gas-permeable protective layer 60 having a thickness of about 15 μm is disposed above capacitive humidity sensor 20 in opening 31 of encapsulation 30. Protective layer 60 preferably has hydrophobic or water-repellent properties and extends over the entire area of opening 31. Protective layer 60 in particular protects all metallic structures of the inventive humidity sensor assembly from external influences.

The specific configuration of a first exemplary embodiment of the inventive humidity sensor assembly will now be further described in detail with reference to FIGS. 2-5.

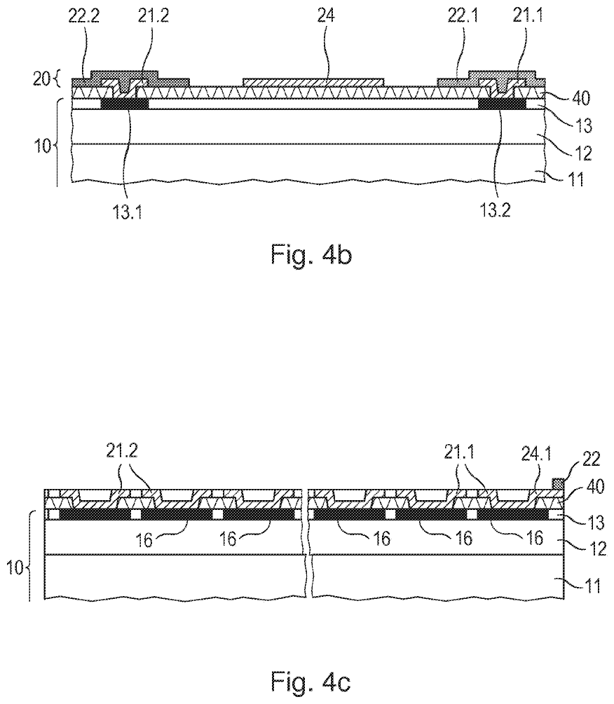

As can be seen from the cross-sectional views of FIGS. 4a-4c, signal-processing component 10 is bounded by an uppermost metal wiring plane 13 at, and over the entire surface area of, its top side, which faces humidity sensor 20. Disposed in uppermost metal wiring plane 13 are, inter alia, contact regions 16 of signal-processing component 10, via which the latter is connected to carrier element 50. Also provided there are further contact regions 13.1, 13.2, via which signal-processing component 10 is connected to the humidity sensor 20 disposed thereabove.

In the present case, further wiring planes 12 of signal-processing component 10 are located below uppermost metal wiring plane 13. Disposed in region 11 therebelow are integrated semiconductor circuits (not specifically shown), which serve, for example, to process the signals generated by humidity sensor 20.

In the exemplary embodiment shown, a passivation layer 40 is disposed over uppermost metal wiring plane 13 over the entire surface area thereof, the passivation layer being formed, for example, from SiO₂ and SiNO and serving to protect the underlying layers from moisture influences. As can be seen from FIG. 2, passivation layer 40 covers the entire top side of signal processing component 10 and has openings at the locations of contact regions 16 for the bond wires 16a to be disposed there, as well as central openings for the contact points of humidity sensor 20.

In the inventive assembly, the humidity sensor is configured above passivation layer 40 as a capacitive humidity sensor 20 in the form of a parallel-plate capacitor. To this end, the single-piece or multi-piece, planar bottom electrode 21.1, 21.2 is disposed in a bottom electrode plane located above passivation layer 40. Preferably, the material used for bottom electrode 21.1, 21.2 is a suitable conductive material, such as metal, for example, gold. In the present first exemplary embodiment, bottom electrode 21.1, 21.2 has a two-piece design, as can be seen, for example, in FIG. 2. The bottom electrode includes two circular segment-shaped bottom electrodes 21.1, 21.2 which are arranged in mirror symmetry to each other and disposed in the region of the projection of circular opening 31 of encapsulation 30 in the bottom electrode plane. The two circular segment-shaped bottom electrodes 21.1, 21.2 cover only a portion of the circular projection of opening in this plane.

In the region of opening 31 of encapsulation 30, or, in the first exemplary embodiment shown, in the portion of the circular projection of the opening that is not covered by bottom electrode 21.1, 21.2, at least portions of a low-resistance, electrically conductive dissipation element 24 are disposed in the bottom electrode plane. In the event of an electrostatic discharge in the vicinity of the sensor assembly, dissipation element 24 ensures that the resulting discharge current can be dissipated at least to the extent that sensitive portions of the underlying signal-processing component 10 remain safe. A potential electrostatic discharge will then occur to dissipation element 24 and not to high-resistance humidity sensor 20, which is electrically conductively connected to signal-processing component 10. Dissipation element 24 is composed of a thin metal layer. Suitable for this purpose is, for example, gold, the thickness of the metal layer being about 0.5 μm. Preferably, the metal layer of dissipation element 24 has a lower electrical resistance than other metallic components of capacitive humidity sensor 20, such as, for example, its bottom and top electrodes 21.1, 21.2 and 23.1, 23.2.

As can also be seen in the figures, dissipation element 24 covers only a portion of the projection of the opening and tapers to a point toward the center of the projection of the opening. In the illustrated exemplary embodiment, it is provided that the portions of dissipation element 24 that are located in the region of the projection of the opening be approximately circular segment-shaped, as can be seen in FIG. 2. The center of the associated circle corresponds to the center of opening 31 and its projection. Accordingly, the tip of circular segment-shaped dissipation element 24 is in each case directed toward the center of the opening and its projection. Furthermore, outside the projection of the opening, dissipation element 24 extends on the top side of signal-processing component 10 over the entire surface area thereof, as can also be seen in FIG. 2.

In the event of an electrostatic discharge, dissipation element 24 dissipates the discharge current to ground, and for this purpose has a contact region 24.1 via which it is electrically conductively connected to carrier element 50, in the present case by a bond wire 24.1a, as shown in FIG. 5. For purposes of dissipating the discharge current, carrier element 50 further has a ground terminal 51.1 as shown.

Alternatively, the discharge current may be dissipated to the supply voltage. To accomplish this in such a variant, the terminal corresponding to ground terminal 51.1 may be the supply voltage terminal at which the positive supply voltage is present.

It should also be noted at this point that dissipation element 24 does not necessarily need to have the geometry and arrangement chosen in this example. For example, the dissipation element may be a single-piece or multi-piece construction and, as an alternative to arranging the dissipation element over the entire surface area in the bottom electrode plane, it may also be provided only in a portion of this plane. Moreover, the dissipation element could be formed in one of the metal wiring planes of the signal-processing component. Furthermore, the dissipation element may also be implemented in other geometries in the region of the opening of the encapsulation. For example, it could cover only a portion of the projection of the opening and taper to a point toward the center of the projection of the opening. In general, it is advantageous for the functioning of the dissipation element if the dissipation element is located where the protective layer in the opening has its minimum thickness. In the event of uncontrolled electrostatic discharges, it is then reliably ensured that the discharge current can be reliably dissipated via the dissipation element.

In the exemplary embodiment shown, capacitive humidity sensor 20 further includes measuring layer 22, 22.1, 22.2 in addition to bottom electrode 21.1, 21.2. Measuring layer 22, 22.1, 22.2, which in the present case is formed of multiple pieces, is disposed in a measuring layer plane located above the bottom electrode plane and composed of a material having a moisture-dependent capacitance, such as a suitable dielectric, for example, polyimide. Measuring layer 22, 22.1, 22.2 covers at least a region above bottom electrode 21.1, 21.2 that is equal in area to the geometry of bottom electrode 21.1, 21.2. Furthermore, in the exemplary embodiment shown, measuring layer 22 extends in the measuring layer plane over a large portion of the top side of signal-processing component 10, as can be seen in FIG. 2. However, at least above the circular segment-shaped dissipation element regions in the projection of the opening, no measuring layer is provided. In the region of the at least one dissipation element 24, measuring layer 22, 22.1, 22.2 has cutouts or openings.

The measuring layer plane is followed upwards by the top electrode plane, in which top electrode 23.1, 23.2 is disposed, which in the present case also has a two-piece design, and which is composed of a moisture- and gas-permeable, conductive material. A metal, such as chromium, having cracks to ensure permeability to moisture can be used for this purpose, too. The geometry of the two top electrodes 23.1, 23.2 corresponds to that of bottom electrodes 21.1, 21.2; i.e., two top electrodes 23.1, 23.2 arranged in mirror symmetry to each other are provided in the region of the projection of the opening into the top electrode plane.

Capacitive humidity sensor 20 is operated in known manner, whereby the capacitance of measuring layer 22, 22.1, 22.2, which varies as a function of humidity, is determined, allowing corresponding humidity measurement values to be generated therefrom.

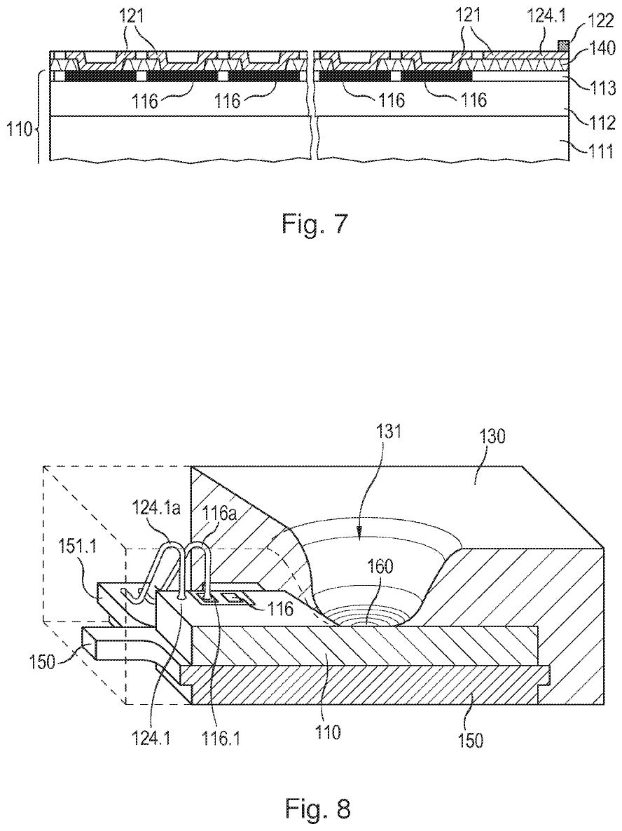

A second exemplary embodiment is described below with reference to FIGS. 6, 7 and 8, which show a plan view, a cross-sectional view and a perspective partial view of this exemplary embodiment. In this connection, only the relevant differences from the first exemplary embodiment will be discussed.

Thus, for example, the second exemplary embodiment provides an alternative way of contacting dissipation element 124. Now, the bond wire 124.1a provided for dissipating the discharge current is not connected to signal-processing component 110 via a separate contact region or a bond pad, but is disposed directly in the region 124.1 on the surface where dissipation element 124 is located. In the case where the discharge current is dissipated to ground, the other end of bond wire 124.1a is in contact with a ground terminal 151.1 on carrier element 150. In this exemplary embodiment, a separate bond wire 16a is provided to connect signal-processing component 110 via contact region 116.1 to ground or to ground terminal 151.1 on carrier element 150. Thus, in this exemplary embodiment, separate bond wires 124.1a, 116a are provided to connect dissipation element 124 and signal-processing component 110 to ground.

This variant provides the advantage of separating the inductances and resistances of dissipation element bond wire 124.1a and bond wire 116a for the ground connection of signal-processing component 110. The voltage drop caused by the dissipation current at separate bond wire 124.1a will then in particular not act in an undefined manner on the supply voltage of signal-processing component 110.

Like the first exemplary embodiment, the second exemplary embodiment may, of course, also be modified in such a way that the discharge current is dissipated to the supply voltage of the signal-processing component. Analogously to the variant described, this is then also accomplished via a separate dissipation element bond wire, while another bond wire is provided for supplying power to the signal processing component.

In addition to the exemplary embodiments specifically described herein, other embodiments are, of course, possible within the scope of the present invention.

For example, rather than providing the capacitive humidity sensor in the form of a flat parallel-plate capacitor, it would be possible to configure the electrodes as an interdigitated structure between which the humidity-sensitive dielectric is placed. The interdigitated structure could be, for example, in one of the metal wiring planes of the signal-processing component.

Furthermore, it is not absolutely necessary that the dissipation element be planar or provided over nearly the entire surface area. Alternatively, for example, the dissipation element could also include only one or more metallic conductive traces routed to a ground terminal, etc.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A humidity sensor assembly comprising:
an integrated signal-processing component,
at least one capacitive humidity sensor disposed on the signal-processing component,
an encapsulation that partially surrounds the signal-processing component and has an opening in a region of the at least one humidity sensor, and
at least one low-resistance, electrically conductive dissipation element is disposed in a region of the opening such that, in an event of an electrostatic discharge, a resulting discharge current is dischargeable through the at least one dissipation element at least to an extent that sensitive portions of the signal-processing component remain safe.

2. The humidity sensor assembly as recited in claim 1, wherein the at least one humidity sensor comprises:
at least one planar bottom electrode disposed on the signal-processing component,
a measuring layer which is disposed above the bottom electrode and whose capacitance varies as a function of humidity, and
at least one moisture-permeable, planar top electrode disposed above the measuring layer.

3. The humidity sensor assembly as recited in claim 2, wherein surfaces of the at least one bottom electrode and/or of the at least one top electrode each cover only a portion of a projection of the opening into a plane of the bottom electrode and/or into a plane of the top electrode.

4. The humidity sensor assembly as recited in claim 3, wherein the at least one dissipation element is disposed at least in a non-covered portion of the projection of the opening in the plane of the bottom electrode.

5. The humidity sensor assembly as recited in claim 2, wherein the opening is circular in cross section, and the at least one bottom electrode and/or the at least one top electrode are each circular segment-shaped in a region of the projection of the opening into the plane of the bottom electrode and/or into the plane of the top electrode.

6. The humidity sensor assembly as recited in claim 5, wherein the at least one bottom electrode and/or the at least one top electrode include(s) two circular segments arranged in mirror symmetry to each other, wherein the at least one dissipation element includes two circular segment-shaped dissipation elements that are disposed at least in regions outside the circular segments, and wherein the dissipation elements are arranged in mirror symmetry to each other.

7. The humidity sensor assembly as recited in claim 4, wherein the at least one dissipation element extends over further surface areas above the signal-processing component outside the projection of the opening.

8. The humidity sensor assembly as recited in claim 7, wherein the at least one dissipation element extends over the entire surface area of the signal-processing component outside the projection of the opening.

9. The humidity sensor assembly as recited in claim 2, wherein:
the signal-processing component has an uppermost metal wiring plane toward the humidity sensor, and
a passivation layer is disposed over the metal wiring plane, and
the at least one bottom electrode and the at least one dissipation element are disposed in a bottom electrode plane located above the passivation layer, and
the measuring layer, which at least includes cutouts in the region of the at least one dissipation element, is disposed in a measuring layer plane located above the bottom electrode plane, and
the at least one top electrode is disposed above the at least one bottom electrode in a top electrode plane located above the measuring layer plane.

10. The humidity sensor assembly as recited in claim 1, wherein the at least one dissipation element is composed of a metal layer.

11. The humidity sensor assembly as recited in claim 10, wherein the metal layer has a lower electrical resistance than other metallic components of the capacitive humidity sensor.

12. The humidity sensor assembly as recited in claim 1, wherein the at least one dissipation element is configured to dissipate the discharge current to ground or to a supply voltage of the signal-processing component.

13. The humidity sensor assembly as recited in claim 12, wherein the at least one dissipation element includes a separate bond wire configured to dissipate the discharge current, and wherein the separate bond wire is not configured to be used for connection to ground or for supplying power to the signal-processing component.

14. The humidity sensor assembly as recited in claim 1, wherein the at least one dissipation element covers only a portion of a projection of the opening and tapers to a point toward a center of the projection of the opening.

15. The humidity sensor assembly as recited in claim 1, wherein a moisture-permeable protective layer is disposed in the opening above the at least one humidity sensor, the at least one dissipation element being located in a region of the opening where the protective layer has a minimum thickness.

16. The humidity sensor assembly as recited in claim 1, wherein the at least one dissipation element has a lower electrical resistance than the sensitive portions of the signal-processing unit such that at least a greater proportion of the discharge current is dischargeable through the at least one dissipation element than through the sensitive portions of the signal-processing unit.
